(19) United States
(12) Patent Application Publication
(10) Pub. No.: US 2004/0090459 A1
(43) Pub. Date: May 13, 2004

(54) Graphical user interface for presenting and manipulating object attributes

(76) Inventor: Omega Hsu, Kaohsiung (TW)

Correspondence Address: BIRCH STEWART KOLASCH & BIRCH, PO BOX 747, FALLS CHURCH, VA, 22040-0747, US

(21) Appl. No.: 10/292,534

(22) Filed: Nov. 13, 2002

(51) Int. Cl. G09G 5/00

(52) U.S. Cl. 345/762

(57) ABSTRACT

A graphical user interface for presenting and manipulating object attributes. The graphical user interface comprises a combo box allowing activation of individual objects and a list showing labels and values of, and pushpin buttons for, the attributes belonging to the active object and the attributes retained to the list by means of the pushpin buttons.

### BACKGROUND OF THE INVENTION

1. Field of the Invention

The present invention relates to a graphical user interface and particularly to a graphical user interface for presenting and manipulating multimedia object attributes in an authoring software application.

2. Description of the Related Art

Over the last two decades, significant increases in personal computer processing capability and equally significant decreases in the cost of such computers has led to the proliferation of personal computers in all aspects of society. Thus, today personal computers are heavily utilized in schools, homes and in business. One factor fueling this proliferation of computers throughout numerous aspects of life has been the introduction and expanded use of graphical user interfaces, which have greatly simplified and made more intuitive both computer operating systems and applications. This simplification has allowed less sophisticated computer users to readily use computers for many applications.

Today, the vast majority of personal computer operating systems and application programs are accessed by users via a graphical user interface. Examples of such operating systems are IBM OS/2, Apple System 7, and Microsoft Windows, and example applications include Microsoft Windows Explorer, Lotus Notes and Word Perfect. These operating systems and applications all provide a windowed workspace for providing users access to applications and information.

A wide variety of operating systems and computer application programs incorporate, display and/or perform operations on data or information which is hierarchical in nature. For example, most computer operating systems provide users access to a hierarchy of directories and sub-directories where documents, programs, e-mail messages and other information are stored. Similarly, organizer applications allow a user to establish task listings, which once again are often hierarchical in nature. With the advent and expanded use of graphical user interfaces, such hierarchical information or data is often displayed to the user in a tree representation. These tree representations visually indicate the level in the hierarchy where each item of data resides, and may allow a user to “expand” or “collapse” the tree at various points (i.e., displaying or hiding information in the lower levels) to facilitate a users viewing of the hierarchical data. Both custom programs, as well as tree viewer objects, are known in the prior art for providing a “tree view” graphical user interface to the user.

While the use of tree viewer objects and custom tree viewer programs has expanded in recent years, so has the complexity of many of the hierarchical data sets provided to the user in tree representation. With this increasing complexity, it has become more important that computer users be provided control mechanisms for manipulating the hierarchical data set and for customizing how the hierarchical data appears on their computer screen. A typical example of such a situation can be seen in multimedia authoring applications used to manipulate multimedia objects with many attributes for each. It is difficult to use this tree-style user interface to perform comparisons of corresponding attributes between different objects since the large number of attributes requires extensive scrolling to view two attributes far from each other in the tree. Accordingly, there is a need for improvements in graphical user interfaces for presenting and manipulating hierarchical data.

### SUMMARY OF THE INVENTION

The object of the present invention is to provide a more convenient graphical user interface for presenting and manipulating object attributes for viewing and comparison.

The present invention provides a graphical user interface for presenting and manipulating object attributes. The graphical user interface comprises a combo box allowing activation of individual objects, a list showing labels and values thereof, corresponding pushpin buttons for retaining the attributes of the active object, and the attributes retained to the list by means of the pushpin buttons.

The present invention also provides a method for operating a graphical user interface for presenting and manipulating object attributes. The method comprises steps of activation of individual objects, listing labels and values of the attributes belonging to the active object, retaining the attributes to which the listed labels and values belong, releasing the attributes to which the listed labels and values belong, and keeping the labels and values of the retained attributes listed when deactivating and activating individual objects.

The present invention further provides a computer device for presenting and manipulating object attributes. The computer device comprises switching means for activating and deactivating individual objects, means for listing labels and values of the attributes belonging to the active object, and means for retaining and releasing the attributes to which the listed labels and values belong, wherein the labels and values of the retained attributes are kept listed by the listing means when individual objects are activated and deactivated by the switching means.

Thus, in the present invention, users are able to activate individual objects to select desired attributes and view only information pertaining only to the desired attributes without the need for excessive scrolling. Thus it is more convenient for multimedia authors to manipulate the attributes.

### BRIEF DESCRIPTION OF THE DRAWINGS

The preferred embodiment of the invention is hereinafter described with reference to the accompanying drawings in which:

FIG. 1 is a flowchart of a method for operating a graphical user interface for presenting and manipulating object attributes according to one embodiment of the invention.

FIG. 2A˜2H are diagrams showing a graphical user inter face according to one embodiment of the invention.

### DETAILED DESCRIPTION OF THE INVENTION

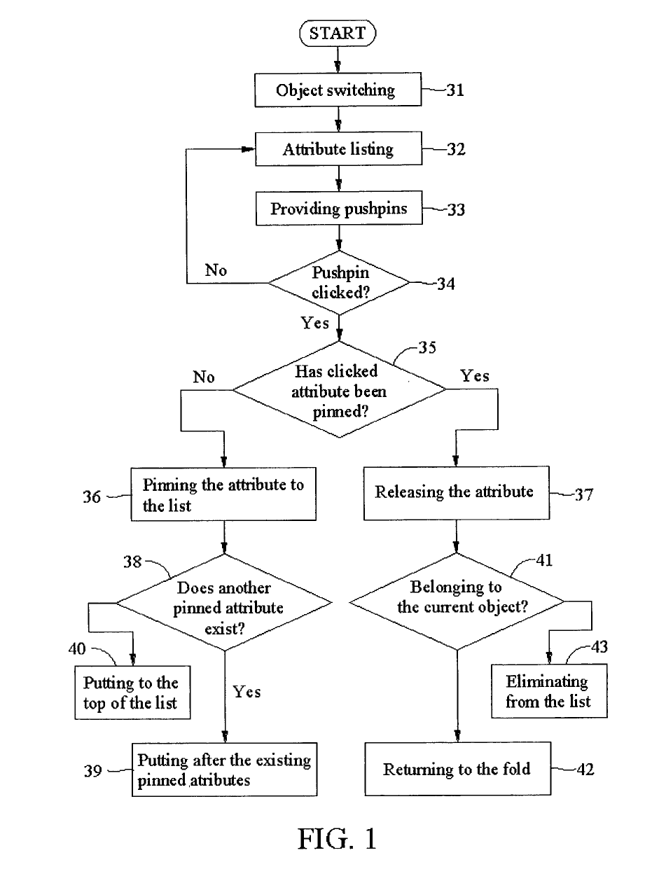

FIG. 1 is a flowchart of a method for operating a graphical user interface for presenting and manipulating object attributes according to one embodiment of the invention.

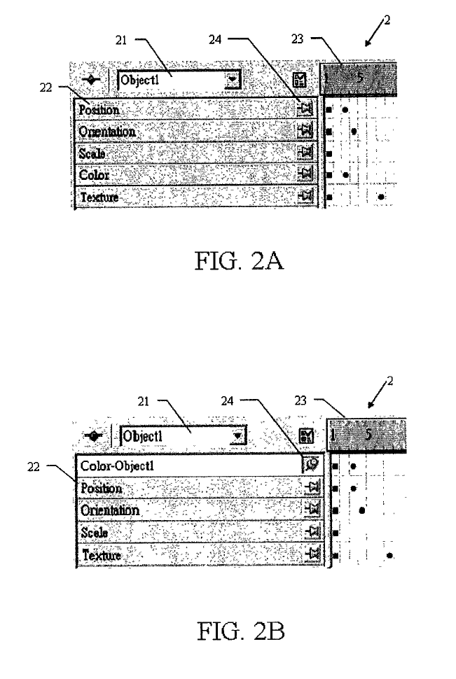

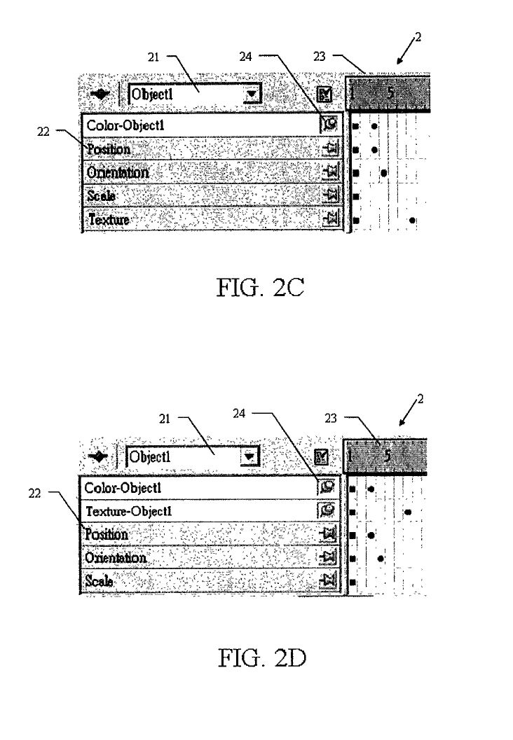

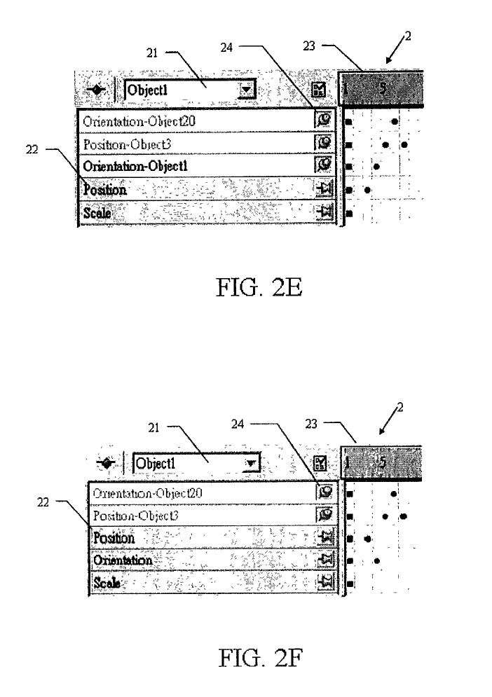

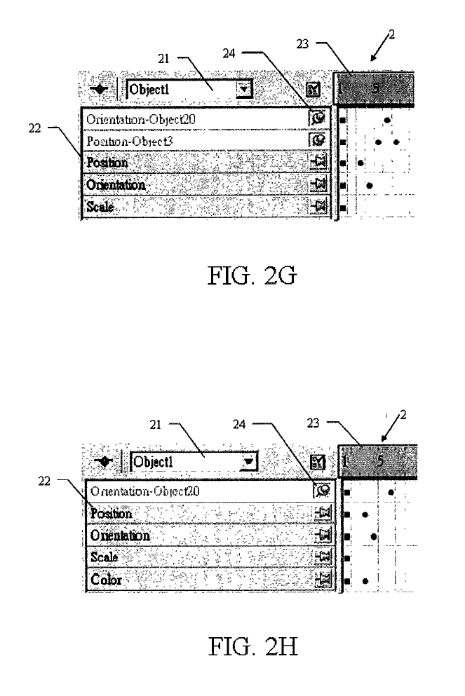

In step 31, as shown in FIG. 2A, a combo box 21 is provided in the graphical user interface 2. When the combo box 21 is clicked, it shows a list of all the objects contained in the current multimedia file and allows the user to activate individual objects. FIG.2A, for example, combo box 21 shows object 1as active.

In step 32, labels 22 and values of the attributes belonging to the active object (object 1) are listed in the graphical user interface 2, as shown in FIG.2A. For example, the active object 1 has 5 attributes labeled as Position, Orientation, Scale, Color and Texture. The values of these attributes are shown in the table 23. Further, the labels and values of previously retained attributes (not shown FIG. 2A and will be explained later) are also shown in the list.

In step 33, a pushpin button 24 is provided next to each of the listed labels 22 for each attribute to allow the users to retain or release the label 22 and values of each attribute to or from the list respectively. The attributes are retained if their pushpin buttons 24 are clicked and released if their pushpin buttons 24 are clicked again.

In step 34, it is determined whether any of the pushpin buttons 24 of the attributes in the list is clicked. If not, and the users switch to another object, step 32 is repeated.

In step 35, it is determined for each clicked pushpin button 24 whether it is in a “toggle on” or “toggle off” state. If on, step 36 is implemented; otherwise, step 37 is implemented.

In step 36, the attributes with pushpin buttons 24 toggled on are retained to the list. Their labels 22 and values are kept in the list despite object activation and deactivation until such time as they are released. In order to distinguish attributes belonging to the different objects, each label of the retained attributes includes an index of its corresponding object, as shown in FIG. 2B.

In Step 37, retained attributes with pushpin buttons 24 toggled on are released. The object index in each corresponding label is eliminated.

In step 38, it is determined whether any previously retained attribute is listed. If so, step 39 is implemented; otherwise, step 40 is implemented.

In step 39, labels and values of the retained attributes are moved up to immediately follow previously retained listed attributes.

In step 40, the labels and values of the retained attributes are moved to the top of the list.

In step 41, it is determined whether the released attributes belong to the active object. If so, step 42 is implemented; otherwise, step 43 is implemented.

In step 42, the labels 24 and values of the released attributes are moved downward to resume default listing position.

In step 43, the labels 24 and values of the released attributes are eliminated from the list.

FIG. 2A˜2H are diagrams showing specific examples of operation of the graphical user interface in the previously described embodiment of the invention.

FIG.2A and 2B show an operation from step 31 to 40. The active object is object 1, as shown in FIG. 2A. The user clicks the pushpin button 24 for the attribute Color. Accordingly, the index “Object 1” is added to the label 22 of the retained attribute Color which is now “Color-Object 1”, and the label 22 and value of the attribute Color is moved upward to the top of the list since there are no other retained attributes, as shown in FIG. 2B.

FIG.2C and 2D show an operation from step 31 to 39. The active object is object 1 and the attribute Color has been retained to the list, as shown in FIG. The user clicks the pushpin button 24 for the attribute Texture. Accordingly, the index “Object 1” is added to the label 22 of the retained attribute Texture which is now “Texture-Object 1”, and the label 22 and value of the attribute Texture is moved upward to immediately follow those of the previously retained attribute Color, as shown in FIG. 2D.

FIG.2E and 2F show an operation from steps 31 to 42. The active object is object 1, and the attribute Orientation of the object 20, Position of the object 3 and Orientation of the object 1 have been retained to the list, as shown in FIG. 2E. The user clicks the pushpin button 24 for the retained attribute Orientation of the object 1. Accordingly, the index “Object 1” is eliminated from its label 22 which is now “Orientation”, and the label 22 and value of the attribute Orientation of the object 1 is moved downward to resume default listing position since the object 1 is active, as shown in FIG. 2F.

FIG.2G and 2H show an operation from steps 31 to 43. The active object is object 1, and the attributes Orientation of the object 20 and Position of the object 3 have been retained to the list, as shown in FIG. 2E. The user clicks the pushpin button 24 for the retained attribute Position of the object 3. Accordingly, its label 22 and value are eliminated from the list since the object 3 is not currently switched to by the combo box 21.

In conclusion, the present invention provides a graphical user interface for presenting and manipulating object attributes. Users are able to activate individual objects to select desired attributes and only the information pertaining to the desired attributes without the need for excessive scrolling, which is more convenient for viewing and comparison the attributes of different objects when authoring a multimedia file.

The foregoing description of the preferred embodiments of this invention has been presented for purposes of illustration and description. Obvious modifications or variations are possible in light of the above teaching. The embodiments were chosen and described to provide the best illustration of the principles of this invention and its practical application to thereby enable those skilled in the art to utilize the invention in various embodiments and with various modifications as are suited, to the particular use contemplated. All such modifications and variations are within the scope of the present invention as determined by the appended claims when interpreted in accordance with the breadth to which they are fairly, legally, and equitably entitled.

What is claimed is:

1. A graphical user interface for presenting and manipulating object attributes, comprising:
a combo box allowing activation of individual objects; and
a list showing labels, values, and pushpin buttons for the attributes belonging to the active object and the attributes retained to the list by the pushpin buttons.

2. The graphical user interface as claimed in claim 1, wherein the labels and values of the retained attributes are kept at the top of the list and the labels thereof show indices of the objects to which the retained attributes belong.

3. The graphical user interface as claimed in claim 2, wherein the labels and values of the retained attributes belonging to the active object resume their default listing position and the object indices shown in the labels thereof are eliminated when the corresponding pushpin buttons are toggled off.

4. The graphical user interface as claimed in claim 1, wherein the labels and values of the retained attributes not belonging to the active object are eliminated from the list when the corresponding pushpin buttons are toggled off.

5. A method for operating a graphical user interface for presenting and manipulating object attributes, the method comprising steps of:
activating individual objects;
listing labels and values of the attributes belonging to the active object;
retaining the attributes to which the listed labels and values belong;
releasing the attributes to which the listed labels and values belong; and
keeping the labels and values of the retained attributes listed when deactivating and activating individual objects.

6. The method as claimed in claim 5, wherein the labels and values of the retained attributes are placed at the top of the list and the labels thereof show indices of the objects to which the retained attributes belong.

7. The method as claimed in claim 6 further comprising step of returning to default listing position the labels and values of the retained attributes belonging to the active object and eliminating the object indices shown in the labels thereof when the retained attributes belonging to the active object are released.

8. The method as claimed in claim 5 further comprising step of eliminating from the list the labels and values of the retained attributes which are released and do not belong to the active object.

9. A computer device for presenting and manipulating object attributes, comprising:
switching means for activating and deactivating individual objects;
means for listing labels and values of the attributes belonging to the active object; and
means for retaining and releasing the attributes to which the listed labels and values belong;
wherein the labels and values of the retained attributes are kept listed by the listing means when individual objects are activated and deactivated thereby.

10. The computer device as claimed in claim 9, wherein the listing means places the labels and values of the retained attributes at the top of the listand shows in the labels thereof indices of the objects to which the retained attributes belong.

11. The computer device as claimed in claim 10, wherein the listing means returns the labels and values of the retained attributes belonging to the active object to their default listing position and eliminates the object indices shown in the labels thereof when the retained attributes belonging to the active object are released.

12. The computer device as claimed in claim 9, wherein the listing means eliminates from the list the labels and values of prior retained attributes which are released and do not belong to the active object.
